(19) United States
(12) Patent Application Publication
(10) Pub. No.: US 2010/0138990 A1
(43) Pub. Date: Jun. 10, 2010

(54) Patient Lifting Device

(76) Inventor: Frank Van Oirschot, Chatham (CA)

Correspondence Address: DENNISON ASSOCIATES, 133 RICHMOND STREET WEST, SUITE 301, TORONTO, ON, M5H 2L7, CA

(21) Appl. No.: 12/626,662

(22) Filed: Nov. 26, 2009

(30) Foreign Application Priority Data
Nov. 27, 2008 (CA) 2645428

(51) Int. Cl. A61G 7/10

(52) U.S. Cl. 5/86.1; 5/83.1

(57) ABSTRACT

An inclined lift for patient transfer is designed to allow a patient to be pulled on an inclined ramp which is subsequently movable to a raised generally horizontal position. IN the raised generally horizontal position a patient may be transferred to a chair or to a further horizontal structure such as a bed. In a preferred embodiment the inclined lift includes a patient slide mat that is movable onto the ramp by a retraction mechanism. The patient sits or lies on the mat and a winch type mechanism pulls the mat onto the inclined ramp. There is no requirement for a patient harness to directly pull the patient onto the inclined ramp.

### FIELD OF THE INVENTION

The present invention relates to patient lift arrangements.

### BACKGROUND OF THE INVENTION

The present invention provides an effective lift arrangement for transferring a patient from ground level to a raised level, and allows for subsequent transfer to an appropriate support.

A number of different devices have been proposed, primarily for hospital or institutional-type settings, where a patient is transferred from a wheel chair to a bed or from a wheel chair to a bath. With these devices the patient is effectively lifted and suspended to affect transfer. Such lifting mechanisms assist the care provider in completing the transfer without manual lifting. In recent years there has been a desire to provide proper care for patients in their own home environment as opposed to an institutional setting. One of the difficult challenges for a care provider in the home environment is the lifting of the patient from ground level to an appropriate support such as a chair or bed. Many patients are not capable of lifting themselves to a suitable support structure safely, and the existing lifting-type mechanisms have not been optimized for home use.

### SUMMARY OF THE INVENTION

An inclined lift for patient transfer according to the present invention comprises a base frame supporting an elongate patient support platform that is moveable between an inclined position with one end thereof adjacent ground level and the opposite end at a raised level to a raised position of the platform with both ends of the platform elevated at least 15 inches. The lift further includes a retraction mechanism with a free end thereof engageable with a patient support arrangement. The retraction mechanism is operative to draw the patient support arrangement from ground level in front of the platform when in the inclined position onto the inclined platform which can then be moved to the elevated position.

In a preferred aspect of the invention, the inclined patient lift includes a winched-type arrangement as the retraction mechanism.

According to a further aspect of the invention, the patient support arrangement is a flexible mat with a draw bar member at one end thereof attachable to the retraction mechanism.

In a further aspect of the invention, the flexible mat at an end thereof adjacent the draw bar has a series of strip portions extending in the length of the flexible mat a sufficient distance to assist in removal of the mat supporting a patient on the platform. The draw bar member is removed and this allows the strips to be individually removed from beneath the patient. In a preferred embodiment, the strips are approximately three inches wide and of a length of at least twenty inches.

In yet a further aspect of the invention, the flexible mat at an end thereof adjacent the draw bar has a series of strip portions extending in the length of the flexible mat a sufficient distance to assist in the removal of the mat supporting a patient on said strip portions by progressive removal of the strip portions.

In a further aspect of the invention, the patient support platform includes a first elevating mechanism connecting the base frame and the patient support platform, and operable to raise and lower the one end of the platform between the inclined position and the raised position.

In a further aspect of the invention, the opposite end of the patient support platform is also vertically adjustable relative to the base frame.

According to an aspect of the invention, the one end of the platform can be raised to a slightly higher position than the opposite end of the platform in the raised position. This provides a slope to the opposite end to assist in transfer of the patient by movement along the platform and through the opposite end.

In yet a further aspect of the invention, the incline lift includes removable side rails located on opposite sides of the patient platform.

In yet a further aspect of the invention, the incline lift includes an elevating mechanism associated with both ends of the platform and remote actuators for these elevating mechanisms.

In a preferred aspect of the invention, the patient support platform includes a moveable extension secured to the patient support platform and projecting beyond the base frame that forms the one end of the patient support platform. This moveable extension provides a transition engageable with the floor for movement of the patient onto the patient support platform that is directly above the base frame.

In a further aspect of the invention, the moveable extension is pivotally secured to the patient support platform, and is moveable between an extended position extending beyond the base frame to a storage position overlapping with the patient support platform above the base frame.

In yet a further aspect of the invention, the base frame provides the support for the retraction mechanism and the elevating mechanisms used in the lift.

### BRIEF DESCRIPTION OF THE DRAWINGS

Preferred embodiments of the invention are shown in the drawings, wherein:

FIG. 1 is a side elevation showing the inclined lift being used to transfer a patient from ground level onto the lift;

FIG. 2 shows the inclined lift with the patient now supported on the lift;

FIG. 3 shows the inclined lift with the platform now moved to a raised patient support position;

FIG. 4 shows the elevated platform with further movement of the platform to allow for a reverse of inclination of the platform to assist in transfer of the patient;

FIGS. 5 through 8 show the inclined lift in side view and show the various steps for moving of a patient in a sitting position on the floor to the final reverse inclination of the inclined lift in FIG. 8 (this particular position allows effective transfer of a patient longitudinally of the inclined lift);

FIG. 9 is a top view of the slidable mat;

FIG. 10 is a top view of the removable draw bar;

FIG. 11 is a partial side view of a side rail of the inclined lift; and

FIG. 12 is a partial side view of a drop hinge attachment of the side rail.

### DETAILED DESCRIPTION OF THE PREFERRED EMBODIMENTS

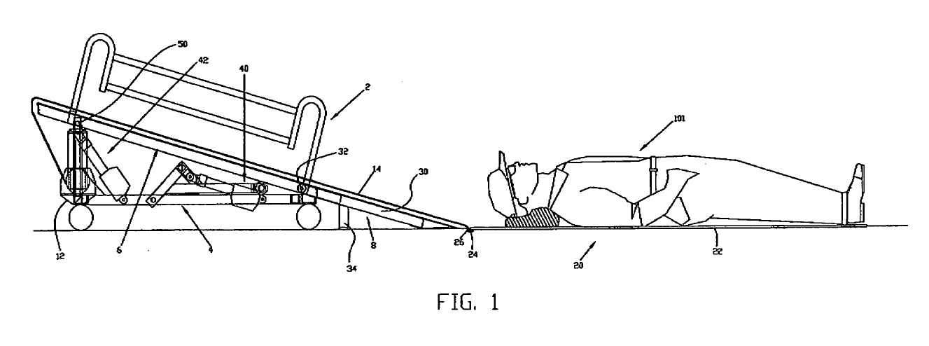

The inclined lift 2 includes a base frame 4 supporting the elongate patient support platform 6 thereabove. The inclined lift as shown in FIG. 1 is positioned in front of a patient 101 who is in a horizontal position supported on the floor. The flexible mat 22 forms the patient support structure and is positioned beneath the patient 101. To accomplish this, the patient can roll to one side allowing the mat to be inserted beneath the patient, and the patient can then shift on the mat to be longitudinally centered. The mat 22 includes a pocket 26 at one end thereof that receives the removable draw bar 24. The removable draw bar 24 is connected to the retraction strap 14 which is part of the retraction mechanism 12 supported above the base frame 4. Actuation of the retraction mechanism 12 draws the patient support mat 22 onto the inclined elongate patient support platform 6.

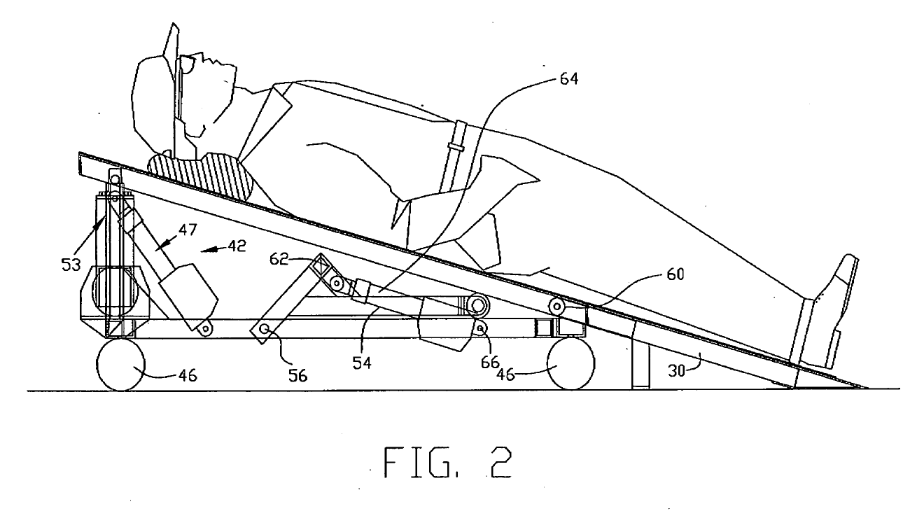

The elongate patient support platform 6 as shown in FIG. 1 includes a moveable extension 30 that is preferably pivotally secured either side of the platform by the pivot connection 32. The moveable extension 30 includes intermediate its length a ground support leg 34. This moveable extension forms a transition of the elongate patient support platform from ground level onto the patient support platform that is centered above the base frame 4. Operation of the retraction mechanism 12 will cause the retraction strap 14 to pull on the draw bar member 24 and pull the flexible mat 22 onto the patient support platform. Further retraction of the retraction mechanism 12 will allow the patient 101 to be fully drawn onto the inclined lift as shown in FIG. 2. Basically, the flexible mat has relatively low friction with the support surface, and with the patient support platform to allow effective movement of the patient from the horizontal position supported on the floor as shown in FIG. 1 to the support position as shown in FIG. 2.

As illustrated with respect to FIG. 2, the base platform is such that most of the patient's weight and the patient's center of gravity will be located on the platform above the base frame 4. This provides effective weight distribution of the patient on the patient support platform, and a stable arrangement as the base frame is effectively supported at opposite ends thereof. The majority of the patient's weight is carried within the length of the base frame. It can also be seen that essentially the patient's legs are only supported on the moveable extension 30.

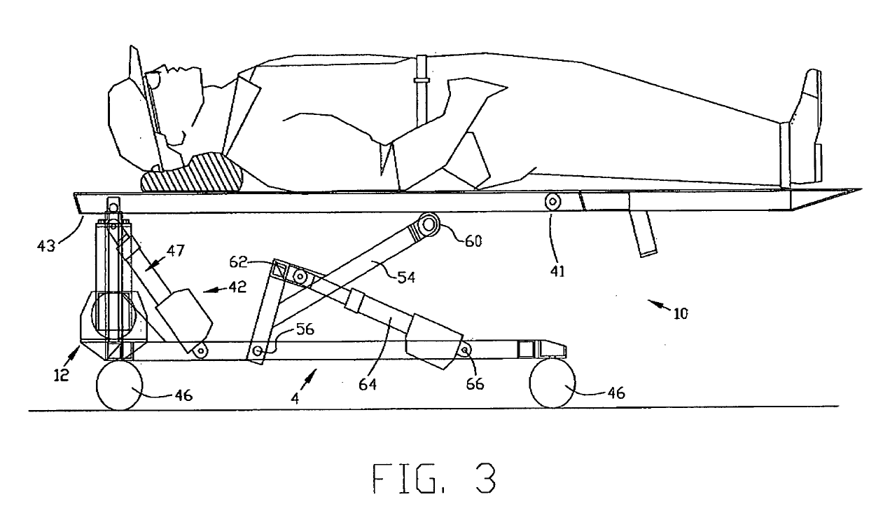

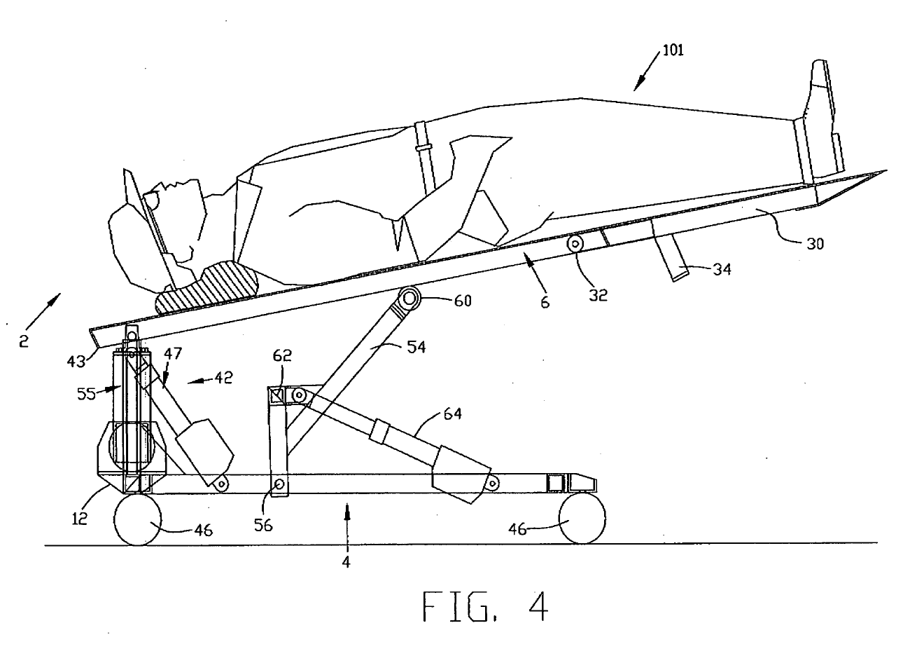

The base frame 4 includes a first elevating mechanism 40 raises the end 41 of the patient support platform 6 to the raised position shown in FIG. 3. Preferably, this elevating mechanism will also allow further raising of the one end 41 to the reverse inclination position of FIG. 4. This reverse inclination provides a shallow angle that will assist in the transfer of the patient 101 from the inclined lift by movement through the opposite end 43 of the inclined lift as will be explained in subsequent figures.

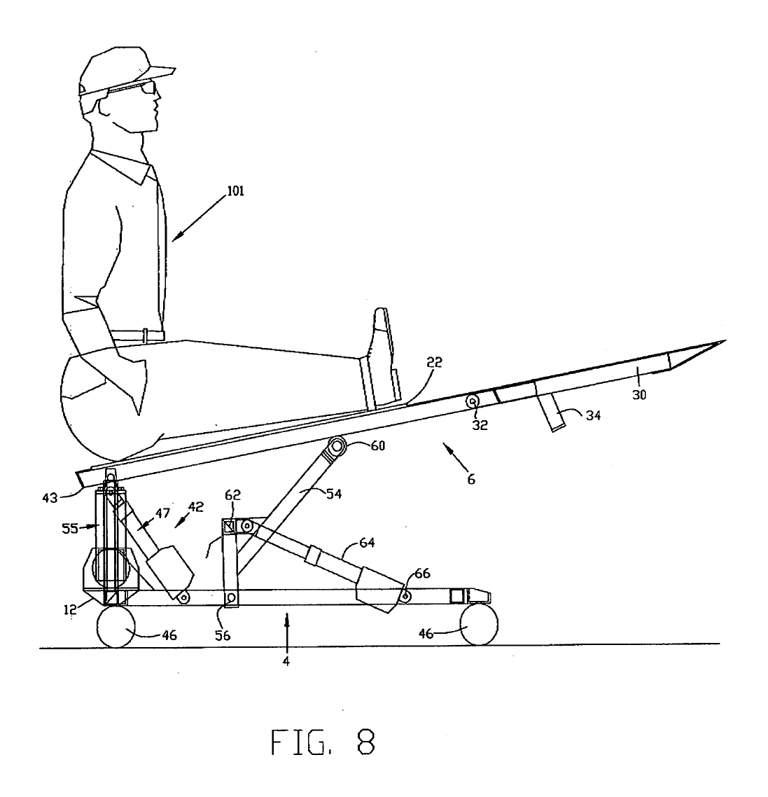

The base frame 4 also includes a second elevating mechanism 42 for vertical adjustment of the end 43 of the platform 6. This simplifies transfer of the patient to an appropriate support structure. For example, it may be desirable to transfer the patient to a wheelchair. Typically, wheelchairs are at different heights between 18 and 24 inches from the ground level to suit the patient. The second elevating mechanism allows appropriate movement of the end 43 such that it is at the approximate height of the support structure to which the patient will be transferred. The ability of the second mechanism to move to the reverse inclination position as shown in FIG. 4 and FIG. 8 provides assistance in transferring of the patient as gravity will allow the patient to partially slide or move along the length of the platform.

The base frame 4 includes support wheels 46 to allow movement of the incline lift to different locations in the premise. These wheels are lockable, or an arrangement for effectively braking of the platform to allow transfer of a patient onto the inclined lift is provided.

The first elevating mechanism 40 is shown as a linkage arrangement that includes an elevating link 54 having a roller 60 for movement along the lower surface of the patient support platform 6. The elevating link 54 is also pivotally connected to the base frame 4 at the pivot connection 56 and has an associated offset arm 62. An actuator 64 in the form of an adjustable length lever is operative to effect the lifting of the platform from the inclined position of FIG. 2 to the raised position and the reverse inclination positions of FIGS. 3 and 4. The opposite end of the platform is also adjustable in height by the second elevating mechanism 42. This includes an adjustable link member 54 that can extend and force the end of the platform 43 to move vertically within telescopic members 53 supporting the one end of the platform. In this way the end 43 can also be moved and it is preferred that this end of the platform has a range of motion of approximately six or more inches.

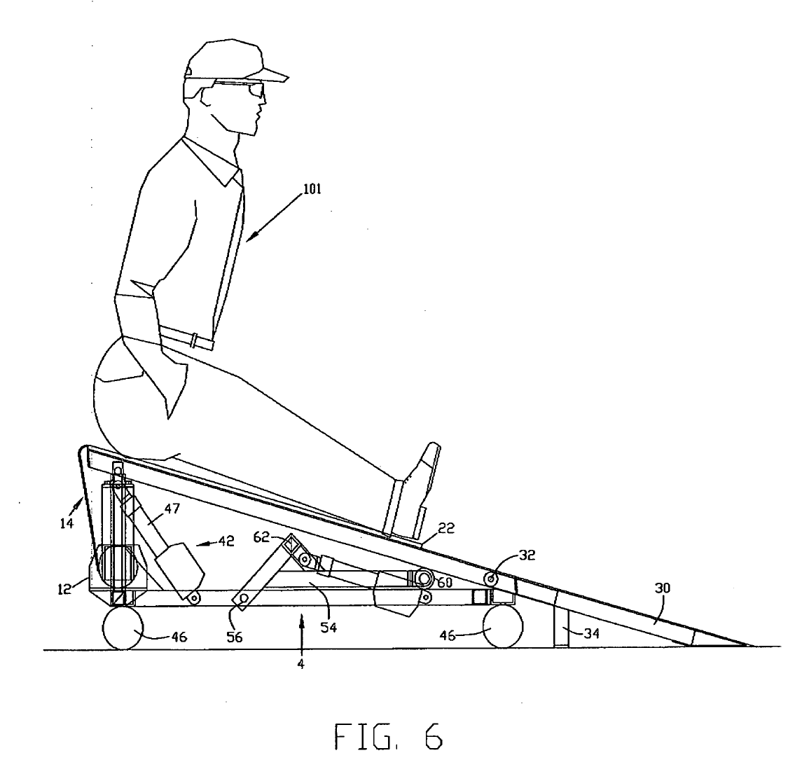

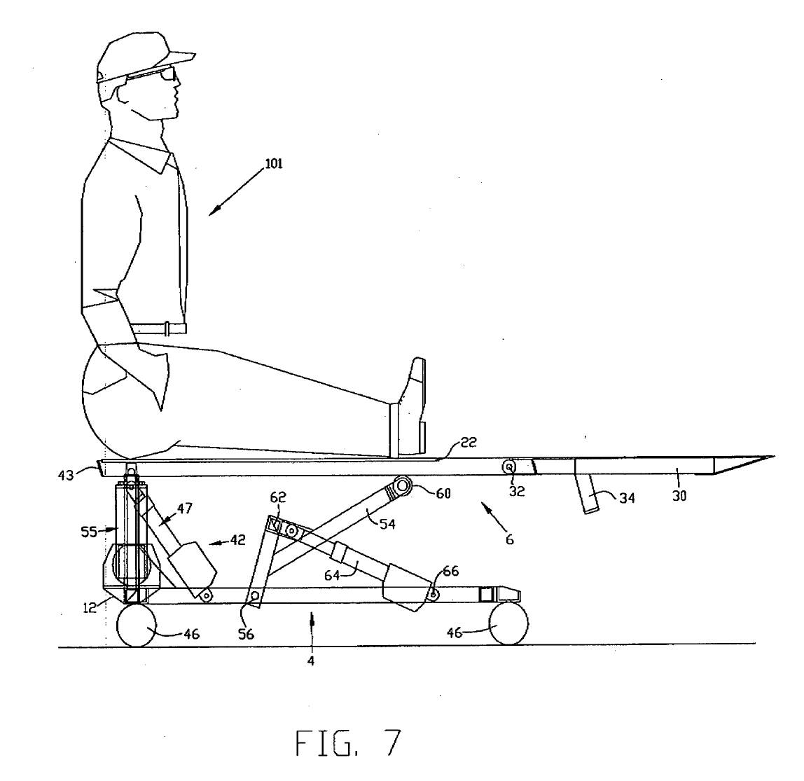

As can be appreciated from FIGS. 1 through 8, the incline lift includes a base frame 4 that is of a shorter length than the overall length of the patient support platform 6. Once a patient has been appropriately drawn onto the patient support platform 6, the patient's weight is effectively directly above the base frame and thus provides a stable support. With this inclined lift, the patient is drawn onto the patient support platform by movement in the length of the platform, and the patient can also be transferred by movement through the opposite end 43 of the platform.

Different elevating mechanisms and different retraction mechanisms can be used.

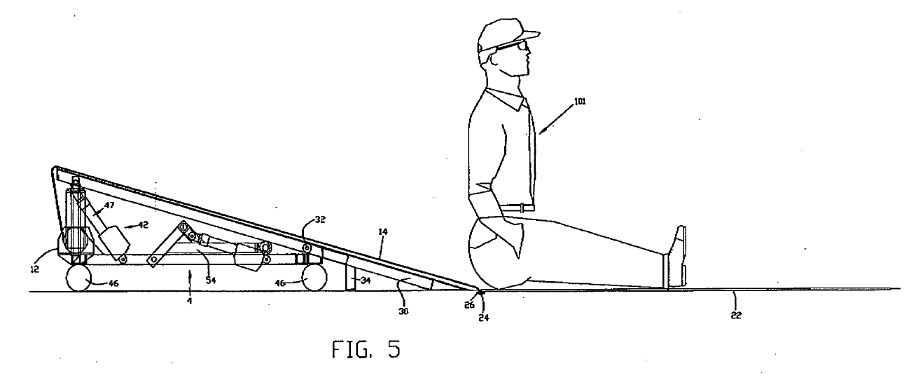

FIGS. 5 through 8 also use the flexible mat structure for effecting transfer of a patient in a sitting position on the floor onto the inclined lift. In this case, the patient prefers to effect transfer in the sitting position, and is again drawn onto the inclined lift. The patient's weight is still effectively supported within the base frame 4 once the patient has been appropriately positioned on the platform.

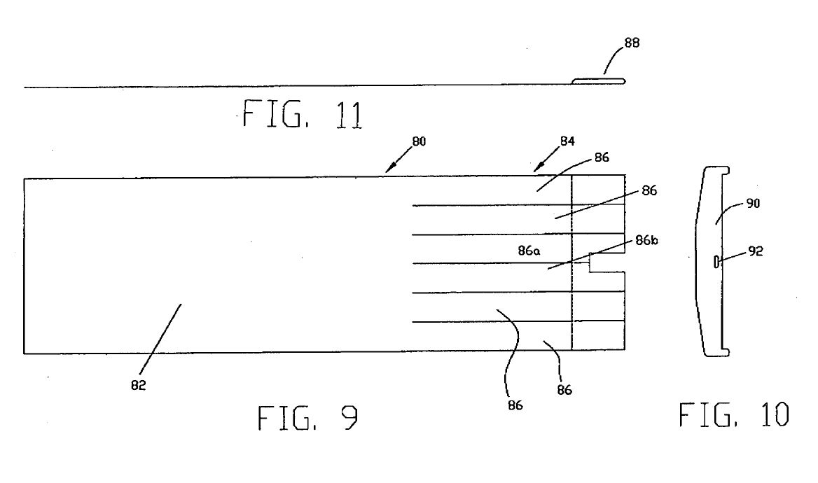

Details of the flexible mat and its connection to the retraction mechanism are shown in FIGS. 9 and 10. The mat 80 is a flexible structure and is of appropriate strength and properties for sliding along a support surface and onto the patient support platform. It includes a non stripped portion generally shown as 82, and a stripped end portion shown as 84. The end 84 includes individual strips shown as 86. The drawbar 90 is insertable into the pocket 88 provided at the one end of the flexible mat. This drawbar includes a connection portion 92 for engagement with the retraction mechanism. Preferably, strips 86a and 86b are partially cut away to allow convenient connection of the drawbar 90 to the retraction mechanism. The strip portions 86 are preferably of a length of at least twenty inches and approximately three inches in width. The lengths of the strips can be increased, and may be as long as thirty six inches. The advantage of the strips is that with the patient on the inclined lift, it may be desirable to remove the flexible mat. In this case, the drawbar 90 can be removed, and the individual strips progressively pulled from beneath the patient. This simplifies the removal of the mat and allows for more convenient use of the lift.

The mat can be made as a two layer construction with a lower surface having properties to provide good durability and appropriate friction for allowing the mat to slide across a floor. The frictional properties are preferably a compromise to allow stability as a patient is getting on the mat while allowing sliding of the mat along a surface and onto the inclined lift. The bottom surface of the mat can be ribbed to reduce the contact area. Although low friction characteristics are desired for sliding movement, inadvertent sliding movement on the support surface and/or on the inclined lift due to patient movement should be avoided.

The top surface of the mat is of a coarser material to prevent the patient from sliding on the mat during loading onto the inclined lift.

It can be appreciated from the drawings that the incline lift is relatively simple in structure and safe in operation to affect transfer of a patient onto the inclined patient platform from one end of the platform, and allows transfer of the patient to a chair or other support from an opposite end of the platform once the platform has been appropriately elevated.

The patient platform preferably has removable rails either side thereof and in a further embodiment, a bed transfer member is connectable along either side of the platform. This bed transfer member 120 is connectible to the support platform using the same connection points of the removable rail. In this case, the inclined lift, with a patient thereon and at a raised position, can be appropriately adjusted to bring the bed transfer member to the appropriate height of the bed and supported on the bed. This can be accomplished by adjustment of the two elevating mechanisms. Once this has been accomplished, the patient can then slide or move onto the bed support structure by movement through the one side of the platform. The device remains stable as the bed provides the support for the transfer when the patient is in an offset position relative to the base 4.

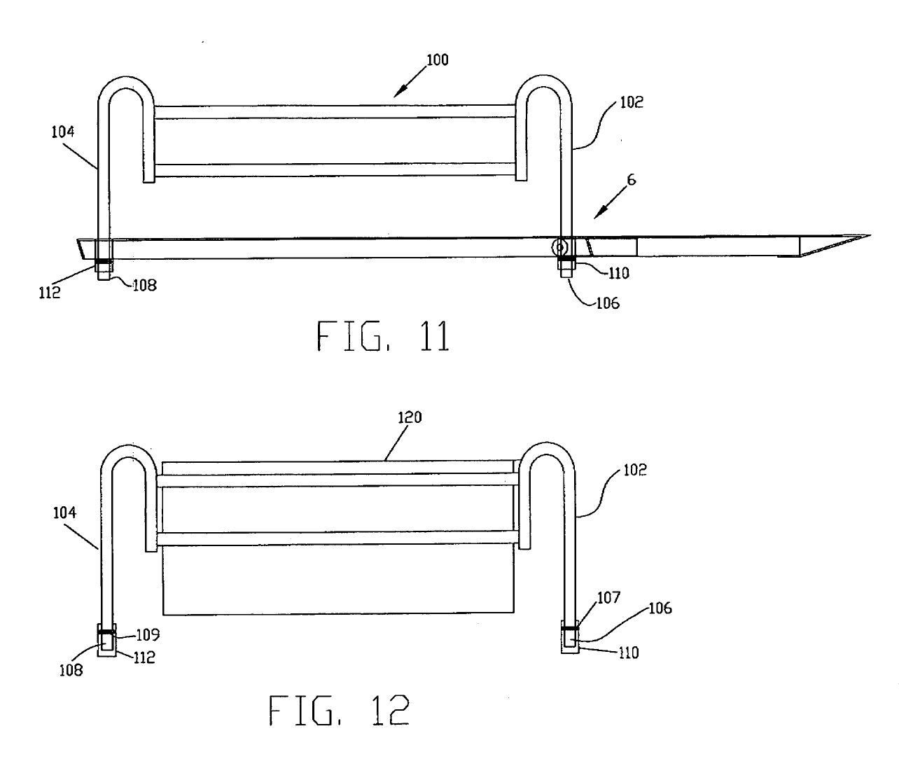

FIG. 11 shows the handrail 100 and its relationship to the patient support platform 6. The handrail 100 includes a support tube 102 at one end thereof, and a similar support tube 104 at the opposite end thereof. Preferably, the handrail is reversible.

The handrail 100 is releasably secured to the patient support platform 6 in that the support tubes 102 and 104 are received within a short stub tube shown as 110 and 112. Basically, the support tubes 102 and 104 bottom out within the stub support tubes 110 and 112.

The free end of each of the support tubes 102 and 104 includes a drop hinge member 106 and 108 respectively. The drop hinge member 106 and 108 allows the handrail to be moved partially upwardly such that the pivot axes 107 and 109 are above the top edge of the stub tubes 110 and 112, allowing the handrail to pivot outwardly to a perpendicular type orientation. This allows the handrail to move to a position where it could be supported on an adjacent bed. As can be appreciated from FIG. 12, when the support tubes 102 and 104 are fully received within the stub tubes 110 and 112, the handrail cannot pivot, and is maintained in the vertical orientation of FIG. 11.

As shown in FIG. 12, the handrail can also include a slide transfer plate 120 which can be attached to the handrail and will provide a slide surface to assist the patient in transferring from the inclined lift to an adjacent bed. There is no requirement for both handrails to have this capability, as the handrails provided either side of the inclined lift are reversible, and therefore the handrail can be located to the appropriate side of the inclined lift.

In an alternate embodiment the slide transfer plate 120 and the siderail are made as a single component where the top edge of the slide transfer plate forms the handrail. Preferably a tubular frame member is provided around the slide transfer plate with the upper edge including at least two spaced notches forming hand grip ports at an upper edge of the slide transfer plate. The drop hinge arrangement for securing of the slide transfer plate to the patient support platform is secured at a lower edge of the slide plate.

The drop hinge can include an elongate slot for receiving a hinge pin fixed to the support platform. With the siderail fully raised in a vertical orientation, the hinge pin is at the bottom of the elongate slot. The siderail can then move downwardly (hinge pin moving to an upper part of the elongate slot) and engage an edge of the patient support frame such that the siderail is secured or locked in the vertical orientation. The rails when raised are pivotal 180° to a suspended non-use position below the patient support platform.

There are other arrangements for securing of the handrail to the inclined lift. For example, these handrails could be supported in the manner similar to handrails provided on hospital beds. These handrails are supported on a hinge mechanism to allow movement downwardly to a clear position and upwardly to the guard position. A suitable arrangement for allowing the pivoting to the 90° configuration will assist in securing of the slide plate 120 and provides a simple mechanism for transferring of a patient from the lift to a bed.

The drop hinge arrangement can also be designed to allow movement of the handrail to a lower position by pivoting through an angle of approximately 180°.

It is preferable that the slide transfer plate 120 be made of an ultra high molecular weight plastic type material to assist in transferring of the patient across the transfer plate.

It can be appreciated from the above description and drawings that the inclined lift provides an effective arrangement for transfer of patients and has particular application for home or domestic use. The inclined extension when the device is not in use can be folded back about the pivot connection and is effectively supported on top of the patient support platform.

The inclined lift may also have application in hospitals and other institutional environments.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. An inclined lift for patient transfer comprising a base frame supporting an elongate patient support platform and movable between an inclined position with one end thereof adjacent ground level and the opposite end at a raised level to a raised position with both ends of said platform at an elevated position at least 15 inches above ground level; said lift further including a retraction mechanism with a free end thereof engagable with a patient support arrangement, said retraction mechanism being operative to draw said patient support arrangement from ground level in front of said platform when in said inclined position onto said inclined platform which can then be moved to said elevated position.

2. An inclined patient lift as claimed in claim 1 wherein said retraction mechanism is a winch type arrangement.

3. An inclined patient lift as claimed in claim 1 wherein said patient support arrangement is a flexible mat with a draw bar member at one end thereof attachable to said retraction mechanism.

4. An inclined patient lift as claimed in claim 3 wherein said flexible mat at an end thereof adjacent said draw bar member has a series of strip portions extending in the length of said flexible mat a sufficient distance to assist in removal of said mat supporting a patient of said platform by removal of said draw bar member and removal of said strips located between the patient and said platform.

5. An inclined patient lift as claimed in claim 3 wherein said flexible mat at an end thereof adjacent said draw bar member has a series of strip portions extending in the length of said flexible mat a sufficient distance to assist in removal of said mat supporting a patient on said strip portions by progressive removal of said strips.

6. An inclined patient lift as claimed in claim 5 wherein said strips extend at least 20 inches in the length of said mat and are joined by said draw bar member which is removable to allow said progressive removal of said strips.

7. An inclined lift as claimed in claim 1 wherein said patient support platform includes a first elevating mechanism connecting said base frame and said patient support platform and operable to raise and lower said one end of said platform between said inclined position and said raised position.

8. An inclined lift as claimed in claim 7 wherein said opposite end of said patient support platform is vertically adjustable relative to said base frame.

9. An inclined lift as claimed in claim 8 wherein said opposite end of said patient support platform is open to accommodate transfer of a patient at a raised position of said platform to a further support structure by movement of said along said platform and through said opposite end.

10. An inclined lift as claimed in claim 9 including a second elevating mechanism for vertical adjustment of said one end of said patient support platform relative to said base frame.

11. An inclined lift as claimed in claim 1 including removable side rails located on opposite sides of said patient support platform.

12. An inclined lift as claimed in claim 9 wherein said elevating mechanisms include a remote actuator for operating thereof.

13. An inclined lift as claimed in claim 1 wherein said patient support platform includes a movable extension secured to said patient support platform and projecting beyond said base frame forming said one end of said patient support platform.

14. An inclined lift as claimed in claim 13 wherein said movable extension is pivotally secured to said patient support platform.

15. An inclined lift as claimed in claim 14 wherein said base frame includes four wheels supporting said base frame.

16. An inclined lift as claimed in claim 15 wherein said base frame supports said retraction mechanism and said elevating mechanisms.
